(19) United States
(12) Patent Application Publication
(10) Pub. No.: US 2024/0343565 A1
(43) Pub. Date: Oct. 17, 2024

(54) METHOD AND SYSTEM FOR SUPPLYING REFORMED PRODUCT FROM BY-PRODUCT GAS TO CATALYST REGENERATOR OF CATALYTIC OLEFINS PRODUCTION PROCESS

(71) Applicant: KOREA INSTITUTE OF MACHINERY & MATERIALS, Daejeon (KR)

(72) Inventors: Dae-hoon LEE, Daejeon (KR); Sungkwon JO, Daejeon (KR); Hong Jae KANG, Daejeon (KR); Kwan-Tae Kim, Daejeon (KR); Younghoon SONG, Daejeon (KR)

(21) Appl. No.: 18/430,817

(22) Filed: Feb. 2, 2024

(30) Foreign Application Priority Data
Apr. 14, 2023 (KR) 10-2023-0049495

(51) Int. Cl. C01B 3/38; B01J 38/10

(52) U.S. Cl. CPC C01B 3/388; B01J 38/10; C01B 2203/0261; C01B 2203/063; C01B 2203/0877; C01B 2203/0883; C01B 2203/1241; C01B 2203/1619

(57) ABSTRACT

Provided is a system for supplying a reformed product from by-product gas to a catalyst regenerator of a catalytic olefins production process. The system includes a reactor configured to mix naphtha and a catalyst to produce olefins through a cracking reaction of naphtha, and then separate the coked catalyst and olefins to discharge the coked catalyst, a catalyst regenerator configured to regenerate the coked catalyst introduced from the reactor and recirculate and supply the regenerated catalyst to the reactor, an air supplier configured to supply burning air to the catalyst regenerator, and a catalytic partial oxidation reformer configured to reform by-product gas containing methane as a main component to supply a reformed product containing hydrogen and carbon monoxide as a main component to the catalyst regenerator and regenerate the coked catalyst.

### CROSS-REFERENCE TO RELATED APPLICATION

This application claims priority to and the benefit of Korean Patent Application No. 10-2023-0049495 filed in the Korean Intellectual Property Office on Apr. 14, 2023, the entire contents of which are incorporated herein by reference.

### BACKGROUND OF THE INVENTION

### (a) Field of the Invention

The present invention relates to a method and system for regenerating a coked catalyst during a process of producing olefins from naphtha using a catalytic cracking system, and more particularly, to a method and system for supplying a reformed product from by-product gas to a catalyst regenerator that regenerates a coked catalyst.

### (b) Description of the Related Art

In general, ethylene is a representative basic raw material in petrochemicals. A petrochemical process produces various materials through various processes based on olefin compounds such as ethylene and propylene. Olefin is obtained through the cracking of naphtha or from ethane, and in Korea, olefin compounds such as ethylene are mainly produced using naphtha as a raw material.

The catalytic olefins production process is a process of producing olefins from naphtha through a catalytic reaction in a reactor. Due to the characteristic of an endothermic reaction in this process, the reaction heat of a continuous fluidized bed reactor is insufficient during the process of passing through the reactor. The catalyst through the cracking reaction is coked, and the coked catalyst is regenerated through a catalyst regenerator.

In order to supplement a temperature required for the regeneration reaction during the regeneration process of the catalyst, by-product gas containing methane as a main component is supplied and the by-product gas is burned in the catalyst regenerator to solve coking on the catalyst surface and supplement the heat required for the reaction.

At this time, when the by-product gas containing methane as the main component is supplied to regenerate the catalyst in the catalyst regenerator, the supplied by-product gas is not sufficiently burned in a catalyst layer of the catalyst regenerator, and after burning occurs.

When after burning occurs, the temperature of the catalyst layer while regenerated in the catalyst regenerator is not sufficiently heated, and burring occurs in an empty space at the inner upper end of the catalytic regenerator to overheat the reactor connected to the catalytic regenerator, thereby causing thermal damage to a reactor structure. Accordingly, it is necessary that after burning does not occur. In addition, when using by-product gas as a heat source, the catalyst regenerator needs to be operated stably for a long period of time.

### SUMMARY OF THE INVENTION

The present disclosure attempts to provide a system for supplying a reformed product from by-product gas to a catalyst regenerator that regenerates a cocked catalyst, during a process of producing olefins from naphtha using a catalytic cracking system.

The present disclosure also attempts to provide a method for supplying a reformed product from by-product gas to a catalyst regenerator that regenerates a cocked catalyst, during a process of producing olefins from naphtha using a catalytic cracking system.

An exemplary embodiment of the present invention provides a system for supplying a reformed product from by-product gas to a catalyst regenerator of a catalytic olefins production process including: a reactor configured to mix naphtha and a catalyst to produce olefins through a cracking reaction of naphtha, and then separate the coked catalyst and olefins to discharge the coked catalyst, a catalyst regenerator configured to regenerate the coked catalyst introduced from the reactor and recirculate and supply the regenerated catalyst to the reactor, an air supplier configured to supply burning air to the catalyst regenerator, and a catalytic partial oxidation reformer configured to reform by-product gas containing methane as a main component to supply a reformed product containing hydrogen and carbon monoxide as a main component to the catalyst regenerator and regenerate the coked catalyst.

The catalyst regenerator may include a stand pipe configured to drop the coked catalyst in the reactor, a container configured to accommodate the stand pipe and configure a regeneration space for catalyst regeneration, a center well that is provided on the lower side in the container and accommodate a lower edge of the stand pipe to configure an accommodation space for accommodating the coked catalyst, and a reformed gas supply nozzle configured to supply the reformed product reformed in the catalytic partial oxidation reformer into the center well.

The catalytic partial oxidation reformer may receive air from a first inlet and receive the by-product gas from a second inlet to supply a reformed product containing hydrogen and carbon monoxide as a main component to an outlet through the catalytic partial oxidation reaction, and the outlet may be connected to the reformed gas supply nozzle through a reformed product line.

The system may further include a temperature controller configured to supply the reformed product to the catalyst regenerator by lowering the temperature of the reformed product to less than a predetermined value through a heat exchanger when the temperature of the reformed product supplied from the catalytic partial oxidation reformer to the catalyst regenerator is the predetermined value or higher.

The temperature controller may include a temperature sensor that is provided in the reformed product line to detect the temperature of the supplied reformed product, a first external air line that is provided in the reformed product line to adjust the flow rate according to a detection signal of the temperature sensor and supply external air at a temperature lower than the temperature of the reformed product, a first flow control valve that is provided in the first external air line to control the flow rate of the supplied external air, and a heat exchanger (HE) that is provided in the reformed product line to lower the temperature of the reformed product with external air or cooling water supplied through the first flow control valve.

The catalytic partial oxidation reformer may perform the reforming operation while maintaining the discharge temperature at 650 to 750° C. by supplying an appropriate amount of oxygen and steam compared to hydrocarbons.

A ratio (O₂/C) of oxygen in the air supplied to the catalytic partial oxidation reformer of carbon of hydrocarbons in the by-product gas may be 0.5 to 0.8, and a ratio (S/C) of steam and carbon in hydrocarbons may be 0.1 to 0.4.

The temperature controller may further include a second external air line configured to supply external air supplied to the first flow control valve to the catalytic partial oxidation reformer, and a second flow control valve that is provided in the second external air line to control the flow rate of the supplied external air.

The catalytic partial oxidation reformer may include a first reactor and a second reactor, an air switching valve that switches to receive air to a first inlet of the first reactor and the first inlet of the second reactor, a by-product gas switching valve that switches to receive by-product gas to a second inlet of the first reactor and a second inlet of the second reactor, and a reformed product switching valve that switches to receive the reformed product from the outlet of the first reactor and the outlet of the second reactor.

When one of the first reactor and the second reactor performs a reforming reaction, the other reactor may block the connection to the catalyst regenerator and operate catalyst regeneration.

Another exemplary embodiment of the present invention provides a method for supplying a reformed product from by-product gas to a catalyst regenerator of a catalytic olefins production process, the method including: a first step of supplying a coked catalyst to a regeneration space; a second step of supplying burning air to the regeneration space; a third step of reforming by-product gas containing methane as a main component into a product containing hydrogen and carbon monoxide as a main component through a catalytic partial oxidation method; and a fourth step of supplying the reformed product to the regeneration space to supply a required amount of heat under catalyst fluidized bed conditions in the regeneration space together with the burning air and regenerating the coked catalyst by maintaining the flame.

The first step may be a step of supplying the coked catalyst through a stand pipe connected to a reactor, and the fourth step may be a step of supplying the catalyst and the reformed product to the regeneration space outside the upper portion of a center well by spraying the reformed product upward toward the catalyst into the accommodation space of the center well located in the container of the catalyst regenerator.

The method may further include a fifth step of controlling the temperature of the reformed product supplied to the regeneration space by supplying or blocking external air together with the reformed product according to a temperature condition of the reformed product supplied to the regeneration space.

The fifth step may include a temperature detection step of detecting the temperature of the supplied reformed product, and a heat exchange step of heat-exchanging the reformed product with external air at a lower temperature than the temperature of the reformed product when the temperature of the reformed product is a predetermined value or higher by controlling the flow rate according to a detected temperature signal to lower the temperature of the reformed product to less than the predetermined value.

The third step may be a step of performing a reforming operation while maintaining a discharge temperature at 650 to 750° C. by supplying an appropriate amount of oxygen and steam compared to hydrocarbons.

The third step may be a step of supplying air with a ratio (O₂/C) of oxygen in air and carbon of hydrocarbons in by-product gas of 0.5 to 0.8, and supplying steam and hydrocarbons with a ratio (S/C) of steam and carbon in hydrocarbons of 0.1 to 0.4.

The fifth step may further include a reformed air supply step of supplying air as a raw material of the reformed product by controlling the flow rate of external air in addition to the external air supplied in the heat exchange step.

The third step may include a 31st reforming step of reforming a first reformed product and a 32nd reforming step of reforming a second reformed product, a 31st air selecting step and a 32nd air selecting step of selecting the supply of air to produce a first reformed product and a second reformed product, and a 31st fuel selecting step and a 32nd fuel selecting step of selecting the supply of by-product gas, and the fourth step may include a 41st supply step of selecting the supply of the produced first reformed product and a 42nd supply step of selecting the supply of the produced second reformed product.

According to the exemplary embodiments of the present invention, burning air is supplied to the regeneration space of the catalyst regenerator, and the reformed product containing hydrogen and carbon monoxide as a main component reformed and produced from by-product gas containing methane as a main component is mixed with the coked catalyst to be supplied to the regeneration space, thereby efficiently regenerating the coked catalyst which is uniformly mixed with air in the regeneration space.

In other words, the reformed product containing hydrogen and carbon monoxide as the main component is supplied to the regeneration space and is sufficiently burned in the coked catalyst layer flowing into the regeneration space, so that after burning does not occur. Therefore, the temperature of the catalyst layer while regenerated in the regeneration space is sufficiently heated to be used for catalyst regeneration, thereby preventing overheating of the reactor connected to the catalyst regenerator. As a result, the catalyst regenerator may be operated stably for a long period of time.

### BRIEF DESCRIPTION OF THE DRAWINGS

FIG. 1 is a schematic diagram of a system for supplying a reformed product from by-product gas to a catalyst regenerator in a catalytic olefins production process according to a first exemplary embodiment of the present invention.

FIG. 2 is a cross-sectional view of a connection state between a catalyst regenerator and a catalytic partial oxidation reformer of FIG. 1.

FIG. 3 is a schematic diagram of a system for supplying a reformed product from by-product gas to a catalyst regenerator of a catalytic olefins production process according to a second exemplary embodiment of the present invention.

FIG. 4 is a schematic diagram of a system for supplying a reformed product from by-product gas to a catalyst regenerator of a catalytic olefins production process according to a third exemplary embodiment of the present invention.

FIG. 5 is a flowchart of a method for supplying a reformed product from by-product gas to a catalyst regenerator of a catalytic olefins production process according to a first exemplary embodiment of the present invention.

FIG. 6 is a detailed flowchart of a step of controlling a temperature in FIG. 5.

FIG. 7 is a flowchart of a method for supplying a reformed product from by-product gas to a catalyst regenerator of a catalytic olefins production process according to a second exemplary embodiment of the present invention.

FIG. 8 is a flowchart of a method for supplying a reformed product from by-product gas to a catalyst regenerator of a catalytic olefins production process according to a third exemplary embodiment of the present invention.

### DETAILED DESCRIPTION OF THE EMBODIMENTS

In the following detailed description, only certain exemplary embodiments of the present invention have been shown and described, simply by way of illustration. The present invention can be variously implemented and is not limited to the following exemplary embodiments. The drawings and description are to be regarded as illustrative in nature and not restrictive. Like reference numerals designate like elements throughout the specification.

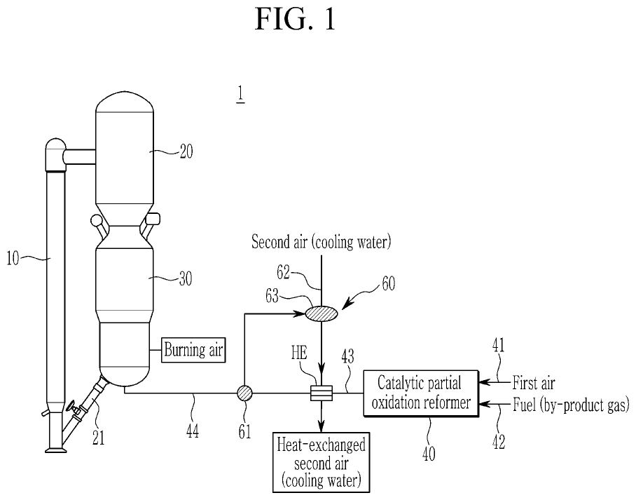

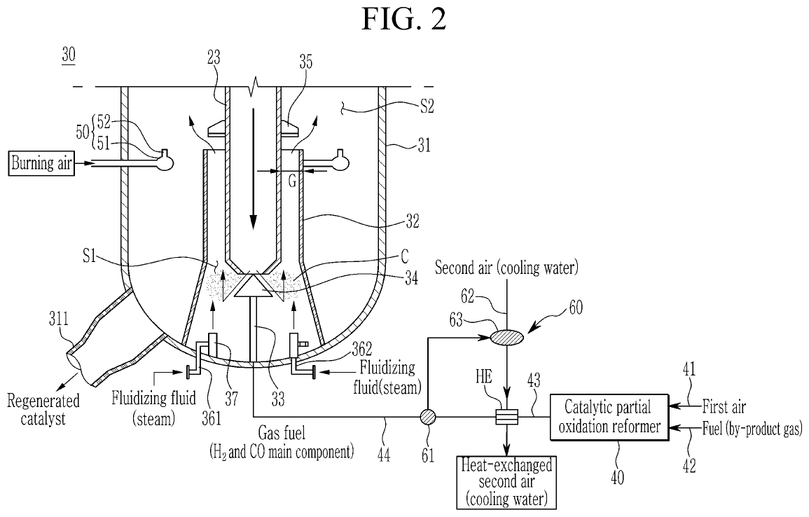

FIG. 1 is a schematic diagram of a system for supplying a reformed product from by-product gas to a catalyst regenerator in a catalytic olefins production process according to a first exemplary embodiment of the present invention and FIG. 2 is a cross-sectional view of a connection state between a catalyst regenerator and a catalytic partial oxidation reformer of FIG. 1.

Referring to FIGS. 1 and 2, a system 1 of a first exemplary embodiment is configured by mixing naphtha and a catalyst in a riser 10 to cause a cracking reaction of naphtha, and then separating the coked catalyst and the produced olefins in a cyclone (not shown) in a reactor 20 to transfer the olefins to a main column (not shown) of FCC.

In addition, the system 1 is configured to discharge the coked catalyst from the reactor 20 to a catalyst regenerator 30, regenerate the coked catalyst flowing into the catalyst regenerator 30 in the catalyst regenerator 30, and recirculate and supply the regenerated catalyst from the catalyst regenerator 30 to the riser 10 and the reactor 20 to be used for a cracking reaction of naphtha.

That is, the naphtha is injected into the lower part of the riser 10 together with steam and starts to be cracked through a catalytic reaction when contacting a high-temperature catalyst. The naphtha is continuously cracked through the catalytic reaction while rising along the riser 10. In addition, the regeneration catalyst regenerated in the catalyst regenerator 30 is recirculated and supplied to the riser 10 through an outlet 311 of a container 31 to serve as a catalyst for the cracking reaction of naphtha.

Since the catalyst acts on the cracking reaction of naphtha, a catalyst covered with solid carbon particles, that is, the coked catalyst, and olefins produced by the cracking reaction of naphtha flow into the cyclone in the reactor 20 to be separated from each other. The coked catalyst separated from the cyclone falls down through a stand pipe 23 connecting the catalyst regenerator 30 in the reactor 20 and flows into the catalyst regenerator 30.

In addition, the system 1 of the first exemplary embodiment further includes a catalytic partial oxidation reformer 40 and an air supplier 50 in order to regenerate the catalyst in the catalyst regenerator 30 and supply a heat source to sufficiently heat the temperature of a catalyst layer C.

The catalytic partial oxidation reformer 40 is configured to efficiently regenerate the coked catalyst mixed with the reformed product in a regeneration space S2 by supplying, to the catalyst regenerator 30, a reformed product containing hydrogen and carbon monoxide as a main component that is reformed and produced from by-product gas as fuel using methane as a main component.

As an example, the catalyst regenerator 30 includes a stand pipe 23, a container 31, a center well 32, and a reformed gas supply nozzle 33. In addition, the catalyst regenerator 30 further includes a dispersion structure 34 provided on the lower side of the stand pipe 23 to disperse the introduced catalyst. The reformed gas supply nozzle 33 is connected to the catalytic partial oxidation reformer 40 to supply the reformed product into the catalyst regenerator 30.

The stand pipe 23 drops the coked catalyst in the reactor 20. The container 31 accommodates the stand pipe 23 and configures the regeneration space S2 for catalyst regeneration. The container 31 has an outlet 311 connected to supply the regenerated catalyst to the riser 10, on one side. The outlet 311 is connected to the lower portion of the riser 10.

The center well 32 is provided on the lower side in the container 31 and accommodates a lower outer side of the stand pipe 23 to configure an accommodation space S1 for accommodating the coked catalyst. The accommodation space S1 accommodates the catalyst layer C formed by accumulating falling catalysts. The catalyst layer C is uniformly accommodated in the accommodation space S1 in a circumferential direction by the dispersion structure 34 in the accommodation space S1 configured by the center well 32.

In the accommodated range, the stand pipe 23 forms a gap G from the center well 32. The catalyst layer C accommodated in the accommodation space S1 of the center well 32 is supplied to the regeneration space S2 through the gap G. The regeneration space S2 is formed above the accommodation space S1.

To this end, the accommodation space S1 is formed under a fluidized bed condition of the catalyst, and a fluidizing fluid for transferring the catalyst is supplied to the accommodation space S1. As an example, a first conduit 361 and a second conduit 362 are connected to the accommodation space S1. The first conduit 361 and the second conduit 362 are connected to a nozzle 37, and steam or nitrogen, which is a fluidizing fluid, is sprayed and supplied to the accommodation space S1 through the nozzle 37.

In the fluidized bed condition of the accommodation space S1, the catalyst is transmitted to the regeneration space S2 configured outside the center well 32 through the gap G between the stand pipe 23 and the center well 32. At this time, a diffusion plate 35 provided on the outer periphery of the stand pipe 23 is spaced upward from the gap G to cover the gap G and uniformly distribute the catalysts transmitted from the accommodation space S1 to the regeneration space S2 in the circumferential direction of the regeneration space S2.

The coked catalyst transmitted to the regeneration space S2 is regenerated in the regeneration space S2 and discharged to the outlet 311 of the container 31 to be supplied to the riser 10. The regenerated catalyst supplied to the riser 10 may be repeatedly used in the cracking reaction of naphtha.

To this end, the reformed gas supply nozzle 33 supplies the reformed product reformed in the catalytic partial oxidation reformer 40 into the center well 32. Although not illustrated separately, the reformed gas supply nozzle 33 is provided below the dispersion structure 34 and sprays the reformed product from the lower side of the dispersion structure 34 to flow upward via the side, flow upward via through holes of the dispersion structure 34, or both thereof.

In addition, the air supplier 50 sprays hot burning air into the regeneration space S2 where the coked catalyst and the reformed product are distributed in a mixed state to help regeneration of the catalyst. As an example, the air supplier 50 includes an air ring 51 provided on the outside of the center well 32 and air nozzles 52 disposed at equal intervals in the air ring 51.

The catalytic partial oxidation reformer 40 supplies a reformed product as fuel to the accommodation space S1 and supplies a mixture of the coked catalyst and the reformed product around the hot air sprayed from the air nozzles 52 to be formed in an easily burning state, thereby regenerating the coked catalyst by maintaining the flame in the regeneration space S2.

That is, when the coked catalyst is regenerated, the catalytic partial oxidation reformer 40 supplies fuel which is the reformed product containing hydrogen and carbon monoxide as a main component to the accommodation space S1 to enable the uniform mixing with the catalyst, thereby uniformly maintaining the flame in the regeneration space S2 to be regenerated while the catalyst mixed with the fuel is distributed.

As an example, the reformed product containing hydrogen and carbon monoxide as a main component may be produced from by-product gas fuel containing methane as a main component. As such, since the reformed product maintains the flame in the regeneration space S2, solid carbon particles covering the catalyst may be sufficiently burned.

The amount of heat supplied through the reformed product during the burning process of the coking material in the regeneration space S2 allows the regeneration catalyst to correspond to the reaction temperature condition of the riser 10. Accordingly, as the regenerated catalyst is supplied to the riser 10, the efficiency of the naphtha cracking reaction in the riser 10 may be further increased.

For example, the catalytic partial oxidation reformer 40 is configured by receiving first air from a first inlet 41 and receiving by-product gas as fuel from a second inlet 42 to produce a reformed product containing hydrogen and carbon monoxide as a main component through a catalytic partial oxidation reaction and supply the reformed product to an outlet 43 in a reformed gas state.

The outlet 43 is connected to the reformed gas supply nozzle 33 through a reformed product line 44. Accordingly, the reformed product produced by the catalytic partial oxidation reforming reaction of the first air and the by-product gas in the catalytic partial oxidation reformer 40 may be supplied to the catalyst regenerator 30.

The catalytic partial oxidation reformer 40 is operated for reforming while maintaining a discharge temperature at 650 to 750° C. by supplying an appropriate amount of oxygen and steam compared to hydrocarbons. Accordingly, the coking material is sufficiently burned in the coked catalyst to regenerate the catalyst.

A ratio (O₂/C) of oxygen (O₂) in first air supplied to the catalytic partial oxidation reformer 40 of carbon of hydrocarbons in the by-product gas is 0.5 to 0.8, and a ratio (S/C) of steam and carbon in hydrocarbons is 0.1 to 0.4. Therefore, the discharge temperature of the reformed product in the catalytic partial oxidation reformer 40 may be maintained at 650 to 750° C.

To perform the regeneration continuously while operating under a condition where O₂/C is between 0.5 and 0.8, which is a normal operating condition of the catalytic partial oxidation reformer 40, the O₂/C value supplied to the catalytic partial oxidation reformer 40 is 2.0 or more, so that excess air may burn a coking material formed in the catalyst in excess air conditions by operating under a fuel lean condition.

A method of increasing the reforming operation condition O₂/C from 0.5 to 0.8 to 2 may increase the supply of the first air or reduce the supply of by-product gas as the fuel. When O₂/C becomes 2 or more, the by-product gas supplied to the catalytic partial oxidation reformer 40 is completely burned, and the reformed product at a high temperature exceeding 750° C. is discharged through the outlet 43.

The system 1 of the first exemplary embodiment may further include a temperature controller 60. The temperature controller 60 is configured to exchange heat in order to lower the temperature of the reformed product according to a temperature condition of the reformed product to be supplied from the catalytic partial oxidation reformer 40 to the catalyst regenerator 30.

When the temperature of the reformed product supplied to the catalyst regenerator 40 is a predetermined value or higher, the temperature controller 60 is configured to lower the temperature of the reformed product to less than the predetermined value through a heat exchanger HE and supply the reformed product to the catalyst regenerator 40. That is, the temperature controller 60 may appropriately control the temperature of the reformed product through heat exchange with the reformed product using cooling water or external air, that is, second air at a relatively low temperature compared to the reformed product.

When the high-temperature reformed product produced in the catalytic partial oxidation reformer 40 is directly supplied to the catalyst regenerator 30, the catalyst in the catalyst regenerator 30 may be exposed to a high temperature, so that the catalyst may be deteriorated. In order to prevent the deterioration, the temperature controller 60 detects the temperature of the reformed product with O₂/C of 2 or more, and heat-exchanges the reformed product to have an appropriate temperature range through heat exchange with the cooling water or the second air to the reformed product when a high-temperature condition of 750° C. or higher is generated. At this time, the temperature controller 60 controls the amount of cooling water or second air so that the reformed product may reach a predetermined temperature range through heat exchange.

For example, the temperature controller 60 includes a temperature sensor 61, a first external air line 62, a first flow control valve 63, and a heat exchanger HE. The temperature sensor 61 is provided in the reformed product line 44 and detects the temperature of the supplied reformed product. The first external air line 62 is provided in the reformed product line 44 to control the flow rate according to a detection signal of the temperature sensor 61, and supplies external second air or cooling water for heat exchange at a temperature lower than the temperature of the reformed product. The first flow control valve 63 is provided in the first external air line 62 to supply the external second air or cooling water to the heat exchanger HE by controlling the flow rate of the supplied external second air or cooling water. The heat exchanger HE is provided in the reformed product line 44 and lowers the temperature of the reformed product by heat exchange with the reformed product with the external second air or cooling water supplied through the first flow control valve 63. The low-temperature second air or cooling water supplied to the heat exchanger HE is discharged at a high temperature after heat exchange.

That is, when the temperature sensor 61 detects the temperature of the reformed product during operation with O₂/C of 2 or more and the high temperature condition of 750° C. or higher is generated, the first flow control valve 63 is controlled to supply the external second air or cooling water for heat exchange to the heat exchanger HE by controlling the flow rate of the second air or cooling water and heat exchange the reformed product, thereby controlling the temperature of the reformed product to an appropriate range. At this time, the flow rate of the second air or cooling water for heat exchange is controlled based on the temperature after heat exchange of the reformed product, so that the reformed product controlled to an optimal temperature may be supplied to the catalyst regenerator 30.

At this time, the catalytic partial oxidation reformer 40 is provided as a single unit and connected to the catalyst regenerator 30 through the reformed product line 44 and may be used by performing repetitively a reforming operation through the first air and by-product gas for a predetermined time and a regeneration operation of regenerating the catalyst inside the catalytic partial oxidation reformer 40 for a predetermined time.

Hereinafter, various exemplary embodiments of the present invention will be described. Compared to the first exemplary embodiment and the previously described exemplary embodiments, the same configurations will be omitted and other different configurations will be described.

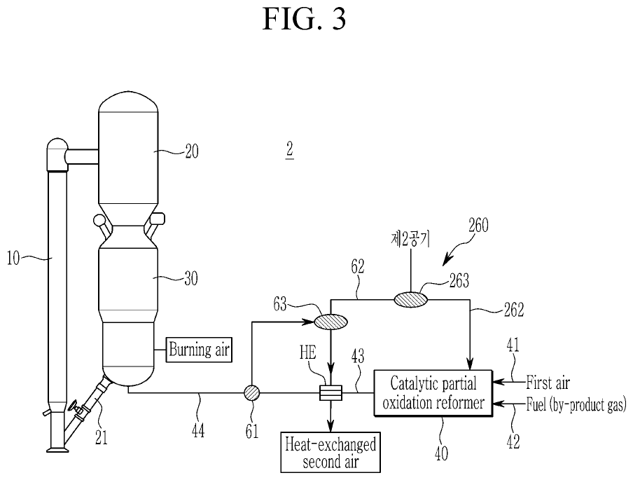

FIG. 3 is a schematic diagram of a system for supplying a reformed product from by-product gas to a catalyst regenerator of a catalytic olefins production process according to a second exemplary embodiment of the present invention. Referring to FIG. 3, a temperature controller 260 in a system 2 of the second exemplary embodiment further includes a second external air line 262 and a second flow control valve 263 in the temperature controller 60 of the first exemplary embodiment.

The second external air line 262 supplies external second air for heat exchange supplied to the first flow control valve 63 to the catalytic partial oxidation reformer 40. The second flow control valve 263 is provided in the second external air line 262 and controls the flow rate of the external second air supplied for heat exchange.

The second air, which has a relatively low temperature compared to the first air, is additionally supplied to the catalytic partial oxidation reformer 40 through the second flow control valve 263 and the second external air line 262 to prevent overheating of the catalyst in the catalytic partial oxidation reformer 40 due to a lean burn operation based on complete burning of by-product gas as the supplied fuel. As a result, the temperature of the reformed product discharged to the reformed product line 44 may be appropriately controlled.

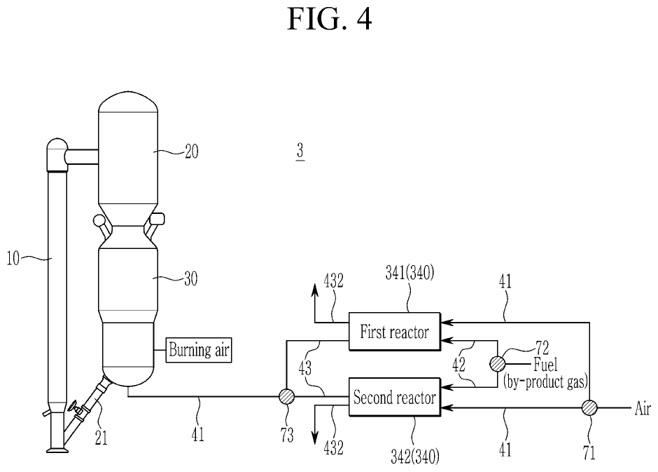

FIG. 4 is a schematic diagram of a system for supplying a reformed product from by-product gas to a catalyst regenerator of a catalytic olefins production process according to a third exemplary embodiment of the present invention. Referring to FIG. 4, in a system 3 of the third exemplary embodiment, a catalytic partial oxidation reformer 340 includes a first reactor 341 and a second reactor 342.

The temperature controllers 60 and 260 of the first and second exemplary embodiments are not shown in FIG. 4, but may also be provided. Due to the first reactor 341 and the second reactor 342, the system 3 further includes an air switching valve 71, a by-product gas switching valve 72, and a reformed product switching valve 73.

The air switching valve 71 switches to receive air from a first inlet 41 of the first reactor 341 and the first inlet 41 of the second reactor 342. The by-product gas switching valve 72 switches to receive the by-product gas from a second inlet 42 of the first reactor 341 and the second inlet 42 of the second reactor 342.

According to the switching operation of the air switching valve 71 and the by-product gas switching valve 72, the first air and the by-product gas are supplied to the first reactor 341 or the second reactor 342 to perform reforming by catalytic partial oxidation.

The reformed product switching valve 73 switches to receive the reformed product from the outlet 43 of the first reactor 341 and the outlet 43 of the second reactor 342. According to the switching of the reformed product switching valve 73, the reformed product reformed and produced in the first reactor 341 or the second reactor 342 may be supplied to the reformed product line 44.

The first reactor 341 and the second reactor 342 enable continuous operation under the same conditions. That is, the reforming operation of the first reactor 341 is operated to supply the reformed product to the catalyst regenerator 30, and the second reactor 342 is supplied with excess first air under lean burn conditions to remove the coking material on the catalyst surface. As such, when one of the first reactor 341 and the second reactor 342 performs a reforming reaction, the other reactor may block the connected to the catalyst regenerator 30 and operate the catalyst regeneration.

Thereafter, when the catalyst of the first reactor 341 is coked through an appropriate operation time, through selection or appropriate flow rate control of the air switching valve 71, the by-product gas switching valve 72, and the reformed product switching valve 73, the second reactor 342 performs the reforming operation to supply the reformed product to the catalyst regenerator 30, and the first reactor 341 is supplied with excess first air under lean burn conditions to remove the coking material of the catalyst surface.

When regenerating the catalyst in the second reactor 342, stream from which the coking material is removed in the second reactor 342 is discharged to the outside of the second reactor 342. To this end, the second reactor 342 is provided with a second outlet 432. When regenerating the catalyst in the first reactor 341, the stream from which the coking material is removed in the first reactor 341 is discharged to the outside of the first reactor 341. To this end, the first reactor 341 includes a second outlet 432.

When the catalyst regeneration time of the first reactor 341 or the second reactor 342 is relatively short, while the first and second reactors 341 and 342 on one side are operating, the second and first reactors 342 and 341 on the other side may also be maintained in a standby state after catalyst regeneration.

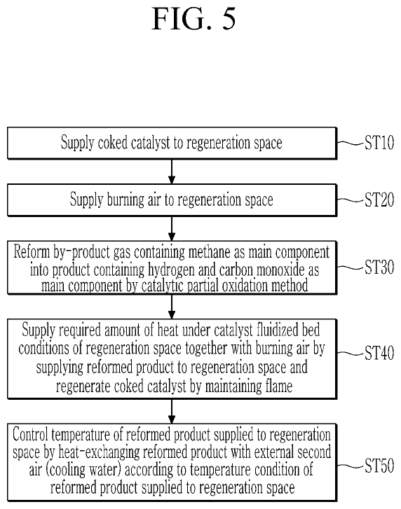

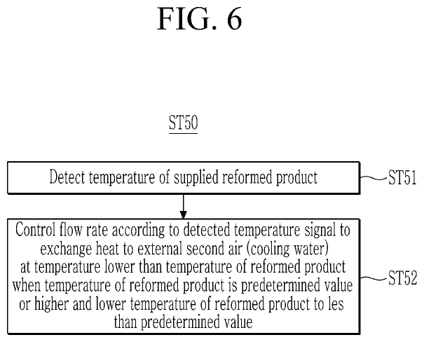

FIG. 5 is a flowchart of a method for supplying a reformed product from by-product gas to a catalyst regenerator of a catalytic olefins production process according to a first exemplary embodiment of the present invention and FIG. 6 is a detailed flowchart of a step of controlling a temperature in FIG. 5.

Referring to FIGS. 5 and 6, the method of the first exemplary embodiment using the system 1 of the first exemplary embodiment may be applied to the process of regenerating the coked catalyst during the process of producing olefins from naphtha using the catalytic cracking system. The method of the first exemplary embodiment includes a first step (ST10), a second step (ST20), a third step (ST30), and a fourth step (ST40).

The first step (ST10) is a step of supplying a coked catalyst covered with solid carbon particles to the regeneration space S2. The second step (ST20) is a step of supplying burning air to the regeneration space S2. The third step (ST30) is a step of reforming by-product gas containing methane as a main component into a product containing hydrogen and carbon monoxide as a main component through a catalytic partial oxidation method. The fourth step (ST40) is a step of supplying the reformed product from the accommodation space S1 to the regeneration space S2 to supply a required amount of heat under catalyst fluidized bed conditions in the regeneration space S2 together with the burning air and regenerating the coked catalyst by maintaining the flame.

The first step (ST10) is a step of collecting the coked catalyst separated from the reaction product in the previous process and supplying the cocked catalyst from the reactor 20 to the accommodation space S1 configured inside the center well 33 through the stand pipe 23.

The third step (ST30) is a step of performing a reforming operation while maintaining a discharge temperature at 650 to 750° C. by supplying an appropriate amount of oxygen and steam compared to hydrocarbons. In addition, the third step (ST30) is a step of first supplying air with a ratio (O₂/C) of oxygen in the first air and carbon of hydrocarbons in the by-product gas of 0.5 to 0.8, and supplying steam and hydrocarbons with a ratio (S/C) of steam and carbon in hydrocarbons of 0.1 to 0.4.

The fourth step (ST40) is a step of supplying the catalyst C and the reformed product to the regeneration space S2 outside the upper portion of the center well 32 by spraying the reformed product upward toward the catalyst C into the accommodation space S1 of the center well 32 located in the container 31 of the catalyst regenerator 30. The reformed product is mixed with a fluidizing fluid (steam) and the catalyst C to be supplied to the regeneration space S2.

The burning air supplied to the regeneration space S2 in the second step (ST20) and the reformed product produced in the third step (ST30) are mixed in the regeneration space S2 to be reacted and burned in the fourth step (ST40) to help the regeneration of the catalyst by maintaining the flame in the regeneration space S2 in which the catalyst is distributed. The regenerated catalyst, in which the solid carbon particles covering the catalyst have been burned, is supplied again to the riser 10 through the outlet 311 of the container 31, mixed with naphtha, and used in the cracking reaction of naphtha.

The method of the first exemplary embodiment further includes a fifth step (ST50). The fifth step (ST50) is a step of controlling the temperature of the reformed product supplied to the regeneration space S2 by heat-exchanging the reformed product with the external second air or cooling water according to a temperature condition of the reformed product supplied to the regeneration space S2.

As an example, the fifth step (ST50) includes a temperature detection step (ST51) of detecting the temperature of the supplied reformed product, and a heat exchange step (ST52) of heat-exchanging the reformed product with external air, that is, second air or cooling water at a lower temperature than the temperature of the reformed product when the temperature of the reformed product is a predetermined value or higher by controlling the flow rate according to a detected temperature signal to lower the temperature of the reformed product to less than the predetermined value.

In more detail, the fifth step (ST50) is a step of detecting the temperature of the reformed product by the temperature sensor 61 during the operation at O₂/C of 2 or more and supplying external second air or cooling water for heat exchange by controlling the first flow control valve 63 to control the flow rate of the first air when the high-temperature condition of 750° C. or higher is generated to heat-exchange the reformed product. As a result, the reformed product is controlled to an appropriate temperature range.

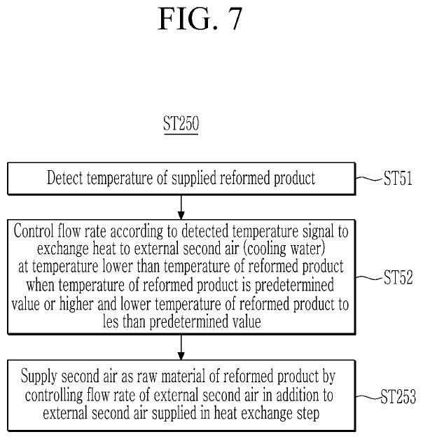

FIG. 7 is a flowchart of a method for supplying a reformed product from by-product gas to a catalyst regenerator of a catalytic olefins production process according to a second exemplary embodiment of the present invention. Referring to FIG. 7, the fifth step (ST250) further includes a reformed air supply step (ST253) of further supplying second air as a raw material of the reformed product by controlling the flow rate of the second air in addition to the external second air supplied in the heat exchange step (ST52).

The reformed air supply step (ST253) is a step of further supplying the second air at a relatively low temperature compared to the first air to the catalytic partial oxidation reformer 40 to enable a lean burn operation based on complete burning of the by-product gas, which is the supplied fuel, thereby preventing the overheating of the catalyst in the catalytic partial oxidation reformer 40. As a result, the fifth step (ST250) is a step of further appropriately controlling the temperature of the reformed product.

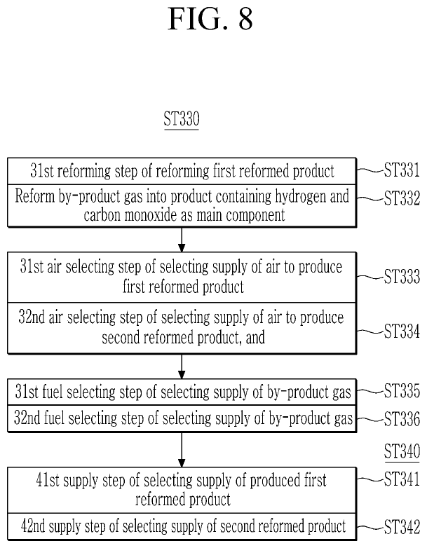

FIG. 8 is a flowchart of a method for supplying a reformed product from by-product gas to a catalyst regenerator of a catalytic olefins production process according to a third exemplary embodiment of the present invention. Referring to FIG. 8, a third step (ST330) includes a 31st reforming step (ST331) of reforming a first reformed product and a 32nd reforming step (ST332) of reforming a second reformed product, and includes a 31st air selecting step (ST341) and a 32nd air selecting step (ST342) of selecting the supply of air to produce a first reformed product and a second reformed product, and includes a 31st fuel selecting step (ST351) and a 32nd fuel selecting step (ST352) of selecting the supply of by-product gas. The fourth step (ST340) includes a 41st supply step (ST341) of selecting the supply of the produced first reformed product and a 42nd supply step (ST342) of selecting the supply of the produced second reformed product.

For example, the 31st air selecting step (ST341) is a step of selecting the supply of the air to the first reactor 341 and controlling the flow rate, the 31st fuel selecting step (ST351) is a step of selecting the supply of the by-product gas to the first reactor 341 and controlling the flow rate, and the 31st reforming step (ST331) is a step of reforming the air and the by-product gas into the first reformed product in the first reactor 341. The 41st supply step (ST341) is a step of selecting the supply of the first reformed product produced in the first reactor 341.

At this time, the 32nd air selecting step (ST342) is a step of selecting the supply of the air to the second reactor 342 and controlling the flow rate, the 32nd fuel selecting step (ST352) is a step of selecting the supply of the by-product gas to the second reactor 342 and controlling the flow rate, and the 32nd reforming step (ST332) is a step of regenerating the catalyst in the second reactor 342 under lean burn conditions using the air and the by-product gas in the second reactor 342. At this time, the stream from which the coking material is removed in the second reactor 342 is discharged to the outside of the second reactor 342.

On the other hand, the 32nd air selecting step (ST342) is a step of selecting the supply of the air to the second reactor 342 and controlling the flow rate, the 32nd fuel selecting step (ST352) is a step of selecting the supply of the by-product gas to the second reactor 342 and controlling the flow rate, and the 32nd reforming step (ST332) is a step of reforming the air and the by-product gas into the second reformed product in the second reactor 342. The 42nd supply step (ST342) is a step of selecting the supply of the second reformed product produced in the second reactor 342.

At this time, the 31st air selecting step (ST341) is a step of selecting the supply of the air to the first reactor 341 and controlling the flow rate, the 31st fuel selecting step (ST351) is a step of selecting the supply of the by-product gas to the first reactor 341 and controlling the flow rate, and the 31st reforming step (ST331) is a step of regenerating the catalyst in the first reactor 341 under lean burn conditions using the air and the by-product gas in the first reactor 341. At this time, the stream from which the coking material is removed in the first reactor 341 is discharged to the outside of the first reactor 341.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

<Description of symbols>

| | |
|---|---|
| 1, 2, 3: System | 10: Riser |
| 20: Reactor | 23: Stand pipe |
| 30: Catalyst regenerator | 31: Container |
| 32: Center well | 33: Reformed gas supply nozzle |
| 34: Dispersion structure | 37: Nozzle |
| 40: Catalytic partial oxidation | 41: First inlet |
| reformer | |
| 42: Second inlet | 43: Outlet |
| 44: Reformed product line | 50: Air supplier |
| 51: Air ring | 52: Air nozzle |
| 60: Temperature controller | 61: Temperature sensor |
| 62: First external air line | 63: First flow control valve |
| 71: Air switching valve | 72: By-product gas switching valve |
| 73: Reformed product switching | |
| valve | |
| 260: Temperature controller | |
| 262: Second external air line | 263: Second flow control valve |
| 311: Outlet | 340: Catalytic partial oxidation |
| | reformer |
| 341: First reactor | 342: Second reactor |
| 361: First conduit | 362: Second conduit |
| C: Catalyst (layer) | G: Gap |
| S1: Accommodation space | S2: Regeneration space |
| HE: Heat exchanger | |

What is claimed is:

1. A system for supplying a reformed product from by-product gas to a catalyst regenerator of a catalytic olefins production process, the system comprising:
a reactor configured to mix naphtha and a catalyst to produce olefins through a cracking reaction of naphtha, and then separate the coked catalyst and olefins to discharge the coked catalyst;
a catalyst regenerator configured to regenerate the coked catalyst introduced from the reactor and recirculate and supply the regenerated catalyst to the reactor;
an air supplier configured to supply burning air to the catalyst regenerator; and
a catalytic partial oxidation reformer configured to reform by-product gas containing methane as a main component to supply a reformed product containing hydrogen and carbon monoxide as a main component to the catalyst regenerator and regenerate the coked catalyst.

2. The system of claim 1, wherein:
the catalyst regenerator comprises
a stand pipe configured to drop the coked catalyst in the reactor,
a container configured to accommodate the stand pipe and configure a regeneration space for catalyst regeneration,
a center well that is provided on the lower side in the container and accommodates a lower edge of the stand pipe to configure an accommodation space for accommodating the coked catalyst, and
a reformed gas supply nozzle configured to supply the reformed product reformed in the catalytic partial oxidation reformer into the center well.

3. The system of claim 2, wherein:
the catalytic partial oxidation reformer is configured by
receiving air from a first inlet and receiving the by-product gas from a second inlet
to supply a reformed product containing hydrogen and carbon monoxide as a main component to an outlet through the catalytic partial oxidation reaction, and
the outlet
is connected to the reformed gas supply nozzle through a reformed product line.

4. The system of claim 1, further comprising:
a temperature controller configured to supply the reformed product to the catalyst regenerator by lowering the temperature of the reformed product to less than a predetermined value through a heat exchanger when the temperature of the reformed product supplied from the catalytic partial oxidation reformer to the catalyst regenerator is the predetermined value or higher.

5. The system of claim 4, wherein:
the temperature controller comprises
a temperature sensor provided in the reformed product line and configured to detect the temperature of the supplied reformed product,
a first external air line provided in the reformed product line, configured to adjust the flow rate according to a detection signal of the temperature sensor and configured to supply external air at a temperature lower than the temperature of the reformed product,
a first flow control valve provided in the first external air line and configured to control the flow rate of the supplied external air, and
a heat exchanger provided in the reformed product line and configured to lower the temperature of the reformed product with external air or cooling water supplied through the first flow control valve.

6. The system of claim 3, wherein:
the catalytic partial oxidation reformer
performs the reforming operation while maintaining the discharge temperature at 650 to 750° C. by supplying an appropriate amount of oxygen and steam compared to hydrocarbons.

7. The system of claim 6, wherein:
a ratio (O₂/C) of oxygen in the air supplied to the catalytic partial oxidation reformer of carbon of hydrocarbons in the by-product gas is 0.5 to 0.8, and
a ratio (S/C) of steam and carbon in hydrocarbons is 0.1 to 0.4.

8. The system of claim 5, wherein:
the temperature controller further comprises
a second external air line configured to supply external air supplied to the first flow control valve to the catalytic partial oxidation reformer, and
a second flow control valve that is provided in the second external air line to control the flow rate of the supplied external air.

9. The system of claim 3, wherein:
the catalytic partial oxidation reformer comprises
a first reactor and a second reactor,
an air switching valve that switches to receive air to a first inlet of the first reactor and the first inlet of the second reactor,
a by-product gas switching valve that switches to receive by-product gas to a second inlet of the first reactor and a second inlet of the second reactor, and
a reformed product switching valve that switches to receive the reformed product from the outlet of the first reactor and the outlet of the second reactor.

10. The system of claim 9, wherein:
when one of the first reactor and the second reactor performs a reforming reaction,
the other reactor blocks the connection to the catalyst regenerator and operates catalyst regeneration.

11. A method for supplying a reformed product from by-product gas to a catalyst regenerator of a catalytic olefins production process, the method comprising:
a first step of supplying a coked catalyst to a regeneration space;
a second step of supplying burning air to the regeneration space;
a third step of reforming by-product gas containing methane as a main component into a product containing hydrogen and carbon monoxide as a main component through a catalytic partial oxidation method; and
a fourth step of supplying the reformed product to the regeneration space to supply a required amount of heat under catalyst fluidized bed conditions in the regeneration space together with the burning air and regenerating the coked catalyst by maintaining the flame.

12. The method of claim 11, wherein:
the first step comprises
supplying the coked catalyst through a stand pipe connected to a reactor,
the fourth step comprises
supplying the catalyst and the reformed product to the regeneration space outside the upper portion of a center well by spraying the reformed product upward toward the catalyst into the accommodation space of the center well located in the container of the catalyst regenerator.

13. The method of claim 11, further comprising:
a fifth step of controlling the temperature of the reformed product supplied to the regeneration space by supplying or blocking external air together with the reformed product according to a temperature condition of the reformed product supplied to the regeneration space.

14. The method of claim 13, wherein:
the fifth step comprises
detecting the temperature of the supplied reformed product, and
heat-exchanging the reformed product with external air at a lower temperature than the temperature of the reformed product when the temperature of the reformed product is a predetermined value or higher by controlling the flow rate according to a detected temperature signal to lower the temperature of the reformed product to less than the predetermined value.

15. The method of claim 11, wherein:
the third step comprises
performing a reforming operation while maintaining a discharge temperature at 650 to 750° C. by supplying an appropriate amount of oxygen and steam compared to hydrocarbons.

16. The method of claim 15, wherein:
the third step comprises
supplying air with a ratio (O₂/C) of oxygen in air and carbon of hydrocarbons in by-product gas of 0.5 to 0.8, and
supplying steam and hydrocarbons with a ratio (S/C) of steam and carbon in hydrocarbons of 0.1 to 0.4.

17. The method of claim 14, wherein:
the fifth step further comprises
supplying air as a raw material of the reformed product by controlling the flow rate of external air in addition to the external air supplied in the heat exchange step.

18. The method of claim 11, wherein:
the third step comprises
a 31st reforming step of reforming a first reformed product and a 32nd reforming step of reforming a second reformed product,
a 31st air selecting step and a 32nd air selecting step of selecting the supply of air to produce a first reformed product and a second reformed product, and
a 31st fuel selecting step and a 32nd fuel selecting step of selecting the supply of by-product gas,
the fourth step comprises
a 41st supply step of selecting the supply of the produced first reformed product and a 42nd supply step of selecting the supply of the produced second reformed product.
